(19) United States
(12) Patent Application Publication
(10) Pub. No.: US 2026/0206846 A1
(43) Pub. Date: Jul. 23, 2026

(54) AEROSOL-GENERATING ARTICLE AND SYSTEM

(71) Applicant: Philip Morris Products S.A., Neuchatel (CH)

(72) Inventors: Guillaume Bastien BAUR, Lausanne (CH); Matteo BOLOGNA, Lausanne (CH); Noori Moyad BRIFCANI, St-Aubin-Sauges (CH); Bruno Christian Joseph CHASSOT, Auvernier (CH); Marie Rose Danielle FARINE, Sugiez (CH); Jerome UTHURRY, Neuchâtel (CH); Esther WAIRIMU, Neuchâtel (CH)

(73) Assignee: Philip Morris Products S.A., Neuchatel (CH)

(21) Appl. No.: 19/137,015

(22) PCT Filed: Dec. 21, 2023
(86) PCT No.: PCT/EP2023/087276

§ 371 Date: Jun. 9, 2025

(30) Foreign Application Priority Data
Dec. 23, 2022 (EP) 22216422

(51) Int. Cl. A24F 40/42; A24B 15/167; A24F 40/20; H05B 3/02

(52) U.S. Cl. CPC A24F 40/42; A24B 15/167; A24F 40/20; H05B 3/02

(57) ABSTRACT

An aerosol-generating system including an aerosol-generating device and an aerosol-generating article for the aerosol-generating device to generate an aerosol is provided, the aerosol-generating device being configured to resistively heat the aerosol-generating article, and the aerosol-generating article including an aerosol-forming substrate including thermally conductive particles, each of the thermally conductive particles having a thermal conductivity of at least 1 W/mK in at least one direction at 25 degrees Celsius, the aerosol-generating article being a planar aerosol-generating article having an article length, an article width, and an article thickness, the article thickness being no more than 0.5 times the article length and no more than 0.5 times the article width.

The present disclosure relates to an aerosol-generating article comprising an aerosol-forming substrate.

A typical aerosol-generating article may appear similar to a conventional cigarette. For example, such an aerosol-generating article may be a substantially cylindrical article comprising an aerosol-forming substrate and other components such as mouthpiece filter element, all wrapped in a cigarette paper. Dimensions of typical aerosol-generating articles are often similar to the dimensions of conventional cigarettes.

Research has shown that, in such a typical aerosol-generating article comprising a plug of aerosol-forming substrate, a significant portion of the plug of aerosol-forming substrate may not be sufficiently heated to form an aerosol during use. This is undesirable since this portion of the plug of aerosol-forming substrate contributes to the cost of manufacture and transport of the aerosol-generating article, but does not contribute to the aerosol delivered to an end user. This may be the case regardless of the way in which the aerosol-forming substrate is heated, for example regardless of whether a resistive or inductive heater is used and regardless of whether the plug of aerosol-forming substrate is heated from the inside or the outside.

It is an aim of the present disclosure to provide an aerosol-generating article, in which a greater portion of an aerosol-forming substrate of the aerosol-generating article is sufficiently heated to form an aerosol during use.

According to a first aspect of the present disclosure, there may be provided an aerosol-generating article for use with an aerosol-generating device to generate an aerosol, the aerosol-generating article being a planar aerosol-generating article having an article length, an article width, and an article thickness, the article thickness being no more than 0.5 times the article length and no more than 0.5 times the article width.

According to a second aspect of the present disclosure, there may be provided an aerosol-generating article comprising an aerosol-forming substrate for producing an aerosol, the aerosol-generating article being a planar aerosol-generating article having a base defined by a length extending in an x direction, a width extending in a y direction, and a height extending in a z direction.

According to a third aspect of the present disclosure, there may be provided an aerosol-generating article comprising an aerosol-forming substrate for producing an aerosol, the aerosol-generating article comprising a substantially planar upper surface defined by a length extending in an x direction and a width extending in a y direction, and a substantially planar lower surface defined by a length extending in an x direction and a width extending in a y direction. The substantially planar upper surface and the substantially planar lower surface may be vertically spaced from each other by a height defined in a z direction.

Advantageously, such articles may have a large base area relative to the volume of the article. Advantageously, a larger base area may provide greater surface area for heating by a planar heater of an aerosol-generating device. Advantageously, a smaller height may allow a smaller temperature gradient or difference across the height of the aerosol-generating article during heating. For example, where the base of the aerosol-generating article is in contact with, and heated by, a planar heater, there may be a smaller temperature difference between the base and an upper surface opposing the base if the spacing, or height, between the base and the upper surface is smaller. Advantageously, this may allow heating of a greater proportion of the aerosol-forming substrate of the aerosol-generating article to a temperature at which an aerosol is released, whilst minimising the risk of burning the hottest portion of the substrate closest to the heater. Alternatively, or in addition, this may reduce a time required to heat the aerosol-forming substrate sufficiently to release an aerosol.

The aerosol-forming substrate may comprise thermally conductive particles. Each of the thermally conductive particles may have a thermal conductivity of at least 1 W/mK in at least one direction at 25 degrees Celsius.

Advantageously, the thermally conductive particles may increase an overall thermal conductivity of the aerosol-forming substrate. Advantageously, the thermally conductive particles may allow a smaller temperature gradient or difference across the substrate during heating. For example, where the base of the substrate is heated, for example by a planar heater, the presence of the thermally conductive particles may result in a smaller temperature difference between the base and an upper surface opposing the base of the substrate. Advantageously, this may allow heating of a greater proportion of the substrate to a temperature at which an aerosol is released, whilst minimising the risk of burning the hottest portion of the substrate closest to the heater. Alternatively, or in addition, the presence of the thermally conductive particles may reduce a time required to heat the substrate sufficiently to release an aerosol.

Thus, according to a particularly preferable fourth aspect of this disclosure, there is provided an aerosol-generating article for use with an aerosol-generating device to generate an aerosol, the aerosol-generating article comprising: an aerosol-forming substrate comprising thermally conductive particles, each of the thermally conductive particles having a thermal conductivity of at least 1 W/mK in at least one direction at 25 degrees Celsius, wherein the aerosol-generating article is a planar aerosol-generating article having an article length, an article width, and an article thickness, the article thickness being no more than 0.5 times the article length and no more than 0.5 times the article width. The optional features described herein may apply to this particularly preferable fourth aspect of this disclosure.

Advantageously, in such an article, the features of the article being planar and the substrate comprising thermally conductive particles may synergistically work together to reduce a temperature gradient across the substrate or article during use, and to reduce a time required to heat the aerosol-forming substrate sufficiently to release an aerosol. These advantages are explained in more detail earlier in this disclosure.

The aerosol-forming substrate may be substantially flat or substantially planar. The aerosol-forming substrate may have a substrate length, a substrate width, and a substrate thickness. The substrate thickness may be no more than 0.5 times the substrate length. The substrate thickness may be no more than 0.5 times the substrate width. The substrate thickness may also be referred to as the substrate height. The substrate thickness, the substrate length and the article width may all be mutually perpendicular.

Such a substrate may have a large base area relative to the volume of the substrate. Advantageously, a larger base area may provide greater surface area for heating by a planar heater of an aerosol-generating device. Advantageously, a smaller height may allow a smaller temperature gradient or difference across the height of the substrate during heating. For example, where the base of the substrate is heated by a planar heater, there may be a smaller temperature difference between the base and an upper surface opposing the base if the spacing, or height, between the base and the upper surface is smaller. Advantageously, this may allow heating of a greater proportion of the substrate to a temperature at which an aerosol is released, whilst minimising the risk of burning the hottest portion of the substrate closest to the heater. Alternatively, or in addition, this may reduce a time required to heat the substrate sufficiently to release an aerosol.

The aerosol-generating article according to any of the aspects disclosed herein may have an air flow path extending through the aerosol-generating article. The aerosol-generating article may have an airflow path defined through the aerosol-generating article in an x/y plane from one side of the aerosol-generating article to the other side of the aerosol-generating article. The aerosol-generating article preferably has a resistance to draw (RTD) of less than 20 millimetre H₂O, for example less than 10 millimetre H₂O, in the direction of the airflow path. Preferably, the aerosol-generating article has a RTD of less than 20 millimetre H₂O, for example less than 10 millimetre H₂O, in at least one direction in an x/y plane of the aerosol-generating article. An aerosol-generating article with a low resistance airflow path may advantageously allow for superior airflow management and allow aerosol to be extracted more efficiently from the aerosol-generating article and guided to a user.

Unless otherwise specified, the resistance to draw (RTD) is measured in accordance with ISO 6565-2015. The RTD refers to the pressure required to force air through the full length of a component, such as the aerosol-generating article. The terms “pressure drop” or “draw resistance” of a component or article may also refer to the “resistance to draw”. Such terms generally refer to the measurements made in accordance with ISO 6565-2015 and are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60%.

The aerosol-generating article according to any of the aspects disclosed herein may comprise substantially planar upper and lower surfaces. A separation, for example a vertical separation, between the substantially planar upper and lower surfaces of the article may define a height (for example, a z dimension) of the aerosol-generating article. This height may be referred to as a thickness, for example the article thickness, herein. An air flow channel may be defined between the substantially planar upper and lower surfaces. The height or article thickness of the aerosol-generating article may be less than 5 millimetres, for example between 1.5 millimetres and 5 millimetres, for example between 1.5 millimetres and 4 millimetres, for example between 1.5 millimetres and 3 millimetres, for example between 1.5 millimetres and 2 millimetres.

The aerosol-generating article may comprise upper and lower layers. At least one of the upper and lower layers may comprise or consist of aerosol-forming substrate. The upper layer may form the substantially planar upper surface and the lower layer may form the substantially planar lower surface.

The aerosol-generating article may comprise a first planar layer. The first planar layer may be the lower layer referred to earlier. The aerosol-generating article may comprise a second planar layer. The second planar layer may be the upper layer referred to earlier. The aerosol-generating article may comprise an intermediate layer. The intermediate layer may be arranged between the first planar layer and the second planar layer. The aerosol-forming forming substrate of the aerosol-generating article may comprise any one, two or all of the first planar layer, the second planar layer and the intermediate layer.

The aerosol-generating article, for example the aerosol-forming substrate of the article, may comprise a corrugated element. The intermediate layer may comprise the corrugated element. The corrugated element may be arranged between the first planar layer and the second planar layer. The aerosol-forming forming substrate of the aerosol-generating article may comprise any one, two or all of the first planar layer, the second planar layer and the corrugated element.

The use of a corrugated structure in the aerosol-generating article may advantageously allow the production of an aerosol-generating article that has extremely low RTD while still being sufficiently rigid to for a user to handle. Further, use of a corrugated structure may allow a low density, low RTD, aerosol-generating article to be produced using high speed production methods similar to those used for production of corrugated cardboard.

Optionally, the corrugated element is or comprises a corrugated sheet of material. The sheet of material may be bent or folded to form corrugations. A thickness of the sheet of material may vary by no more than 50%, 20% or 10%. The sheet of material may have a substantially constant thickness. Advantageously, this may allow a straightforward manufacturing process.

Optionally, at least some of the thermally conductive particles comprise or consist of one or more susceptor materials. Optionally, each of the thermally conductive particles comprises or consists of one or more susceptor materials and is inductively heatable during use of the aerosol-generating article with the aerosol-generating device to a temperature of at least 100, 200 or 300 degrees Celsius. Advantageously, this may allow inductive heating of the thermally conductive particles and thus heating of components comprising or in thermal proximity to the thermally conductive particles.

Suitable susceptor materials include but are not limited to: carbon, carbon-based materials, graphene, graphite, expanded graphite, molybdenum, silicon carbide, stainless steels, niobium, aluminium, nickel, nickel-containing compounds, titanium, and composites of metallic materials. Suitable susceptor materials may comprise a ferromagnetic material, for example, ferritic iron, a ferromagnetic alloy, such as ferromagnetic steel or stainless steel, ferromagnetic particles, and ferrite. A suitable susceptor material may be, or comprise, aluminium. A susceptor material preferably comprises more than 5 percent, preferably more than 20 percent, more preferably more than 50 percent or more than 90 percent of ferromagnetic or paramagnetic materials. Preferred susceptor materials may comprise a metal, metal alloy or carbon.

Particularly preferred susceptor materials may be, or comprise, carbon, carbon-based materials, graphene, graphite, or expanded graphite. Advantageously, such materials have relatively high thermal conductivities, relatively low densities, and may be inductively heated.

Optionally, the first planar layer is adjacent to, optionally in contact with, the corrugated element. Optionally, the first planar layer comprises an aerosol-forming material. Optionally, the first planar layer comprises at least some of the thermally conductive particles.

Optionally, the second planar layer is adjacent to, optionally in contact with, the corrugated element. Optionally, the second planar layer comprises an aerosol-forming material. Optionally, the second planar layer comprises at least some of the thermally conductive particles.

Optionally, the intermediate layer comprises at least some of the thermally conductive particles. Optionally, the corrugated element comprises at least some of the thermally conductive particles.

It may be particularly advantageous for the intermediate layer, or the corrugated element, to comprise at least some of the thermally conductive particles, particularly if one or both of the first and second planar layers comprise aerosol-forming material and are adjacent to, or in contact with, the intermediate layer or the corrugated element. This is because the heating of the intermediate layer or the corrugated element can then be used to influence the heating of the aerosol-forming material of one or both of the first and second planar layers. This is explored in more detail below.

Optionally, the first planar layer has a first region and a second region. Optionally, the first region is closer to the corrugated element than the second region. Optionally, a shortest distance between the first region and the corrugated element is less than a shortest distance between the second region and the corrugated element. Optionally, at least some of the first region is in contact with the corrugated element, for example in contact with a peak or a trough of the corrugated element. Optionally, the second region is not in contact with the corrugated element.

Advantageously, in this scenario, if the corrugated element is heated, for example by inductive heating of thermally conductive particles of the corrugated element, then the corrugated element will heat the first region of the first planar layer more than the second region of the first planar layer. This may advantageously allow heating of the first and second regions of the first planar layer to different temperatures. This may allow preferential vaporisation of different constituents of the first planar layer in the first and second regions. For example, flavourants or botanicals that may not need to be heated to the same temperature as other components, such as nicotine, to be vaporised could be included in or coated onto the second region rather than the first region. Such options are explored in more detail later.

Optionally, the second planar layer has a second planar layer first region and a second planar layer second region. Optionally, the second planar layer first region is closer to the corrugated element than the second planar layer second region. Optionally, a shortest distance between the second planar layer first region and the corrugated element is less than a shortest distance between the second planar layer second region and the corrugated element. Optionally, at least some of the second planar layer first region is in contact with the corrugated element, for example in contact with a peak or a trough of the corrugated element. Optionally, the second planar layer second region is not in contact with the corrugated element. The same advantages may apply to these first and second regions of the second planar layer as set out for the first and second regions of the first planar layer.

Optionally, the first planar layer has one or more first portions and one or more second portions. Optionally, the or each first portion is closer to the corrugated element than the or each second portion. Optionally, a shortest distance between the or each first portion and the corrugated element is less than a shortest distance between the or each second portion and the corrugated element. Optionally, at least some of the or each first portion is in contact with the corrugated element, for example in contact with a peak or a trough of the corrugated element. This may allow preferential vaporisation of different constituents of the first planar layer in the different portions. For example, flavourants that may not need to be heated to the same temperature as other components, such as nicotine, to be vaporised could be included in or coated on the second portions rather than the first portions. Such options are explored in more detail later.

Optionally, there are multiple first portions and each first portion is adjacent to, for example in contact with, a peak or a trough of the corrugated element which no other first portion is adjacent to or in contact with. Optionally, the or each second portion is not in contact with the corrugated element. Optionally, at least one first portion is located between two second portions. Optionally, at least one second portion is located between two first portions.

Optionally, the second planar layer has one or more second planar layer first portions and one or more second planar layer second portions. Optionally, the or each second planar layer first portion is closer to the corrugated element than the or each second planar layer second portion. Optionally, a shortest distance between the or each second planar layer first portion and the corrugated element is less than a shortest distance between the or each second planar layer second portion and the corrugated element. Optionally, at least some of the or each second planar layer first portion is in contact with the corrugated element, for example in contact with a peak or a trough of the corrugated element. The same advantages may apply to these first and second portions of the second planar layer as set out for the first and second portions of the first planar layer.

Optionally, there are multiple second planar layer first portions and each second planar layer first portion is adjacent to, for example in contact with, a peak or a trough of the corrugated element which no other second planar layer first portion is adjacent to or in contact with. Optionally, the or each second planar layer second portion is not in contact with the corrugated element. Optionally, at least one second planar layer first portion is located between two second planar layer second portions. Optionally, at least one second planar layer second portion is located between two second planar layer first portions.

Optionally, the first region has a different material composition to the second region. Optionally, the first region has a coating and the second region does not; or the second region has a coating and the first region does not; or the first region and the second region have different coatings. Optionally, the second region comprises a greater proportion, on a dry weight basis, of at least one component, such as a flavouring or botanical, having a vaporisation temperature of less than 250 or 200 degrees Celsius at atmospheric pressure, than the first region. The features in this paragraph are described in relation to the first and second regions of the first planar layer. However, as the skilled person would understand after reading this disclosure, these features are equally applicable to the first and second regions of the second planar layer, referred to as the second planar layer first region and the second planar layer second region above.

It may be advantageous for the first and second regions to have different compositions or coatings since, as explained before, these regions may be heated to different temperatures in use, for example as a result of the corrugated element comprising thermally conductive particles and heating the first region more than the second region. Thus, as an example, flavourants that may not need to be heated to the same temperature as other components, such as nicotine, to be vaporised could be included in or coated on the second region.

Optionally, the or each first portion has a different material composition to the or each second portion. Optionally: the or each first portion has a coating and the or each second portion does not; or the or each second portion has a coating and the or each first portion does not; or the or each first portion and the or each second portion have different coatings. Optionally, the or each second portion comprises a greater proportion, on a dry weight basis, of at least one component, such as a flavouring or botanical, having a vaporisation temperature of less than 250 or 200 degrees Celsius at atmospheric pressure, than the or each first portion. The features in this paragraph are described in relation to the first and second portions of the first planar layer. However, as the skilled person would understand after reading this disclosure, these features are equally applicable to the first and second portions of the second planar layer, referred to as the second planar layer first portions and the second planar layer second portions above.

As for the first and second regions, it may be advantageous for the first and second portions to have different compositions or coatings since, as explained before, these portions may be heated to different temperatures in use, for example as a result of the corrugated element comprising thermally conductive particles and heating the first portions more than the second portions. It may be advantageous for the first and second portions to have different compositions or coatings since, as explained before, these portions may be heated to different temperatures in use, for example as a result of the corrugated element comprising thermally conductive particles and heating the first portions more than the second portions. Thus, as an example, flavourants that may not need to be heated to the same temperature as other components, such as nicotine, to be vaporised could be included in or coated on the second portions.

As the skilled person would understand after reading this disclosure, where the first planar layer is in contact with one of a peak or a trough of a corrugated element, the second planar layer may be in contact with the other of a peak or a trough of the corrugated element.

Optionally, the first planar layer is substantially parallel to the second planar layer. Optionally, the first planar layer comprises a substantially planar upper surface defined by a length extending in an x direction and a width extending in a y direction. Optionally, the second planar layer comprises a substantially planar lower surface defined by a length extending in an x direction and a width extending in a y direction.

Optionally, the substantially planar upper surface and the substantially planar lower surface are vertically spaced from each other by a height defined in a z direction.

Optionally, the corrugated element is attached to, and optionally in contact with, one or both of the first planar layer and the second planar layer.

Optionally, a first plurality of channels are defined between the first planar layer and the corrugated element. Optionally, a second plurality of channels are defined between the corrugated element and the second planar layer. One or both of the first plurality of channels and the second plurality of channels may form part of an airflow path through the article.

The aerosol-generating article may comprise a first planar external surface and a second planar external surface. The article may comprise a cavity. The article may comprise a frame, for example a planar frame. The frame may be positioned between the first planar external surface and the second planar external surface. The frame may at least partially define the cavity. The aerosol-forming substrate may be positioned between the first planar external surface and the second planar external surface. The article may comprise an air inlet and an air outlet. The article may comprise an airflow passage extending between the air inlet and the air outlet and through the cavity. Aerosol-forming material may be positioned between the first planar external surface and the second planar external surface. At least a portion of the aerosol-forming substrate may be positioned between the first planar external surface and the second planar external surface.

Thus, the article may comprise: a first planar external surface; a second planar external surface; a cavity; a frame, for example a planar frame, positioned between the first planar external surface and the second planar external surface, the frame at least partially defining the cavity; an air inlet; an air outlet; and an airflow passage extending between the air inlet and the air outlet and through the cavity, wherein at least a portion of the aerosol-forming substrate is positioned between the first planar external surface and the second planar external surface.

The frame may comprise a peripheral wall at least partially circumscribing or encircling the cavity. The frame may comprise a peripheral wall wholly circumscribing or encircling the cavity.

The aerosol-generating article may comprise a first planar external layer and a second planar external layer, in which the first planar external layer forms the first planar external surface and the second planar external layer forms the second planar external surface. Optionally, at least one of the first planar external layer, the second planar external layer, and the frame may comprise or consist of aerosol-forming material. The aerosol-forming substrate may comprise any one, two or more of the first planar external layer, the second planar external layer, and the frame. Advantageously, this may allow the article to comprise more aerosol-forming material for a given mass, for example because structural components are not only providing structural integrity but also aerosol-forming material.

The cavity may be substantially empty. Advantageously, this may result in a very low RTD article.

Aerosol-forming material may be positioned within the cavity. At least a portion of the aerosol-forming substrate may be positioned within the cavity. The cavity may advantageously provide a secure area for the aerosol-forming substrate and may allow the airflow path through or past the substrate to be easily tailored with adjustments to the cavity.

A corrugated element, for example the corrugated element discussed earlier in this disclosure, may be positioned within the cavity. Advantageously, the corrugated element may provide only a minimal increase to the RTD of the article.

The corrugated element may comprise at least some of the thermally conductive particles. The corrugated element may comprise an aerosol-forming material.

Optionally, the first planar layer discussed earlier in this disclosure is or comprises the first planar external layer. Optionally, the second planar layer discussed earlier in this disclosure is or comprises the second planar external layer.

Optionally, at least one of the first planar external layer, the second planar external layer, and the frame comprise or consist of aerosol-forming substrate.

Optionally, each of the thermally conductive particles have a thermal conductivity of at least 2, 5, 10, 20, 50, 100, 200 or 500 W/mK in at least one direction at 25 degrees Celsius.

Optionally, some or all of the thermally conductive particles are non-metallic particles. Optionally, some or all of the thermally conductive particles comprise carbon, for example at least 10, 30, 50, 70, 90, 95, 98, or 99 weight percent (wt %) carbon. Optionally, the thermally conductive particles comprise one or more of: graphite particles, expanded graphite particles, diamond particles such as artificial diamond particles, graphene particles, carbon nanotubes, ferrite particles, and charcoal particles. Optionally, some or all of the thermally conductive particles are graphite particles. Optionally, some or all of the thermally conductive particles are expanded graphite particles.

It may be particularly preferable that at least some of the thermally conductive particles are graphite particles. Graphite particles may advantageously be relatively inexpensive, have a relatively high thermal conductivity, and be inductively heated.

Optionally, some or all of the thermally conductive particles comprise one or more of: one or more metals, one or more metallic materials, one or more alloys, and one or more intermetallics. Optionally, some or all of the thermally conductive particles comprise one or more of: copper, aluminium, and nickel. Such particles may advantageously have a relatively high thermal conductivity.

The thermally conductive particles may be characterised by a particle size distribution. The particle size distribution may have number D10, D50 and D90 particle sizes. The number D10 particle size is defined such that 10% of the particles have a particles size less than or equal to the number D10 particle size. Similarly, the number D50 particle size is defined such that 50% of the particles have a particle size less than or equal to the number D50 particle size. Thus, the number D50 particle size may be referred to as a median particle size. The number D90 particle size is defined such that 90% of the particles have a particle size less than or equal to the number D90 particle size. Thus, if there were 1,000 particles in the distribution and the particles were ordered by ascending particle size, one would expect the number D10 particle size to be roughly equal to the particle size of the 100^{th} particle, the number D50 particle size to be roughly equal to the particle size of the 500^{th} particle, and the number D90 particle size to be roughly equal to the particle size of the 900^{th} particle.

The particle size distribution may have volume D10, D50 and D90 particle sizes. The volume D10 particle size is defined such that 10% of the sum of the volumes of all of the particles is accounted for by the sum of the volumes of the particles having a particle size less than or equal to the volume D10 particle size. Similarly, the volume D50 particle size is defined such that 50% of the sum of the volumes of all of the particles is accounted for by the sum of the volumes of the particles having a particle size less than or equal to the volume D50 particle size. And the volume D90 particle size is defined such that 90% of the sum of the volumes of all of the particles is accounted for by the sum of the volumes of the particles having a particle size less than or equal to the volume D90 particle size.

Optionally, the thermally conductive particles have a particle size distribution having a number D10 particle size, wherein the number D10 particle size is at least 0.1, 0.2, 0.5, 1, 2, 5, 10, 20, 50, 100, 200, or 500 microns. Optionally, the thermally conductive particles have a particle size distribution having a number D10 particle size, wherein the number D10 particle size is no more than 1,000, 500, 200, 100, 50, 20, 10, 5, 2, 1, 0.5, or 0.2 microns.

Optionally, the thermally conductive particles have a particle size distribution having a number D50 particle size, wherein the number D50 particle size is at least 0.1, 0.2, 0.5, 1, 2, 5, 10, 20, 50, 100, 200, or 500 microns. Optionally, the thermally conductive particles have a particle size distribution having a number D50 particle size, wherein the number D50 particle size is no more than 1,000, 500, 200, 100, 50, 20, 10, 5, 2, 1, 0.5, or 0.2 microns.

Optionally, the thermally conductive particles have a particle size distribution having a number D90 particle size, wherein the number D90 particle size is at least 0.1, 0.2, 0.5, 1, 2, 5, 10, 20, 50, 100, 200, or 500 microns. Optionally, the thermally conductive particles have a particle size distribution having a number D90 particle size, wherein the number D90 particle size is no more than 1,000, 500, 200, 100, 50, 20, 10, 5, 2, 1, 0.5, or 0.2 microns.

Optionally, the thermally conductive particles have a particle size distribution having a volume D10 particle size, wherein the volume D10 particle size is at least 0.1, 0.2, 0.5, 1, 2, 5, 10, 20, 50, 100, 200, or 500 microns. Optionally, the thermally conductive particles have a particle size distribution having a volume D10 particle size, wherein the volume D10 particle size is no more than 1,000, 500, 200, 100, 50, 20, 10, 5, 2, 1, 0.5, or 0.2 microns

Optionally, the thermally conductive particles have a particle size distribution having a volume D50 particle size, wherein the volume D50 particle size is at least 0.1, 0.2, 0.5, 1, 2, 5, 10, 20, 50, 100, 200, or 500 microns. Optionally, the thermally conductive particles have a particle size distribution having a volume D50 particle size, wherein the volume D50 particle size is no more than 1,000, 500, 200, 100, 50, 20, 10, 5, 2, 1, 0.5, or 0.2 microns.

Optionally, the thermally conductive particles have a particle size distribution having a volume D90 particle size, wherein the volume D90 particle size is at least 0.1, 0.2, 0.5, 1, 2, 5, 10, 20, 50, 100, 200, or 500 microns. Optionally, the thermally conductive particles have a particle size distribution having a volume D90 particle size, wherein the volume D90 particle size is no more than 1,000, 500, 200, 100, 50, 20, 10, 5, 2, 1, 0.5, or 0.2 microns.

A compromise has to be made when deciding the sizes of the particle. Larger thermally conductive particles may advantageously increase the thermal conductivity of the aerosol-forming substrate more than smaller thermally conductive particles. However, larger thermal conductive particles may reduce the space available for aerosol-forming material in the substrate. The particle sizes above may provide an optimal compromise between these factors.

Optionally, the thermally conductive particles have a particle size distribution having a number D10 particle size, a number D90 particle size, a volume D10 particle size, and a volume D90 particle size, wherein: the number D90 particle size is no more than 50, 40, 30, 20, 10, or 5 times the number D10 particle size; or the volume D10 particle size is no more than 50, 40, 30, 20, 10, or 5 times the volume D10 particle size; or both the number D90 particle size is no more than 50, 40, 30, 20, 10, or 5 times the number D10 particle size and the volume D10 particle size is no more than 50, 40, 30, 20, 10, or 5 times the volume D10 particle size.

A compromise must be made in relation to the particle size distribution. A tighter particle size distribution, for example characterised by a smaller ratio between the D90 and D10 particle sizes, may advantageously provide a more uniform thermal conductivity throughout the aerosol-forming substrate. This is because there will be less variation in particle size in different locations in the substrate. This may advantageously allow for more efficient usage of the aerosol-forming material throughout the aerosol-forming substrate. However, a tighter particle size distribution may disadvantageously be more difficult and expensive to achieve. The particle size distributions above may provide an optimal compromise between these factors.

It may be particularly preferable for the thermally conductive particles to have a D10 volume particle size of at least 1 micron, for example between 1 and 20 microns. Alternatively, or in addition, it may be particularly preferable for the thermally conductive particles to have a D90 volume particle size of no more than 300 microns, preferably no more than 200 microns, for example between 30 and 300 microns or between 40 and 200 microns.

Optionally, each of the thermally conductive particles has a particle size of at least 0.1, 0.2, 0.5, 1, 2, 5, 10, 20, 50, 100, 200, or 500 microns. Optionally, each of the thermally conductive particles has a particle size of no more than 1,000, 500, 200, 100, 50, 20, 10, 5, 2, 1, 0.5, or 0.2 microns.

Optionally, each of the thermally conductive particles has three mutually perpendicular dimensions, a largest dimension of the three dimensions being no more than 10, 8, 5, 3, or 2 times larger than one or both of a smallest dimension of the three dimensions and a second largest dimension of the three dimensions. Optionally, each of the thermally conductive particles is substantially spherical.

Advantageously, the orientation of substantially spherical particles may not affect the thermal conductivity of the substrate as much as the orientation of non-spherical particles. Thus, the use of more spherical particles may result in less variability between different substrates where the orientations of the particles is not controlled. In addition, substantially spherical particles may be more easy to characterise.

Optionally, the thermally conductive particles comprise at least 10, 20, 50, 100, 200, 500, or 1000 particles.

Optionally, the substrate comprises, on a dry weight basis, at least 10, 15, 20, 25, 30, 35, 40, 45, 50, 55, 60, 65, 70, 75, 80 or 85 wt% of the thermally conductive particles. Weight percents (wt %s) herein are on a dry weight basis unless in relation to water or moisture or unless it is explicitly otherwise stated. Optionally, the substrate comprises, on a dry weight basis, no more than 85, 80, 75, 70, 65, 60, 55, 50, 45, 40, 35, 30, 25, 20, or 15 wt % of the thermally conductive particles. Optionally, the substrate comprises, on a dry weight basis, between 10 and 90, 20 and 90, 30 and 90, 40 and 90, 50 and 90, 60 and 90, 70 and 90, 80 and 90, 10 and 80, 20 and 80, 30 and 80, 40 and 80, 50 and 80, 60 and 80, 70 and 80, 10 and 70, 20 and 70, 30 and 70, 40 and 70, 50 and 70, 60 and 70, 10 and 60, 20 and 60, 30 and 60, 40 and 60, 50 and 60, 10 and 50, 20 and 50, 30 and 50, 40 and 50, 10 and 40, 20 and 40, 30 and 40, 10 and 30, 20 and 30, or 10 and 20 wt % of the thermally conductive particles.

A compromise must be made in relation to the weight percent of thermally conductive particles in the substrate. Increasing the weight percent of particles in the aerosol-forming substrate may advantageously increase the thermal conductivity of the substrate. However, increasing the weight percent of particles in the aerosol-forming substrate may also reduce the available space for aerosol former, so could result in a substrate which forms less aerosol.

Optionally, the aerosol-forming substrate has a thermal conductivity of greater than 0.05, 0.2, 0.5, 1, or 1.5 W/(mK) in at least one direction, for example all directions, at 25 degrees Celsius.

Optionally, the aerosol-forming substrate has a density of less than 1500, 1050, 1000, 950, 900, 850, 800, 850, 800, 750, 700, or 650kg/m3. Optionally, the aerosol-forming substrate has a density of between 500 and 900 or 600 and 800kg/m3 .

Optionally, the aerosol-forming substrate has a moisture content of between 1 and 20, or 3 and 15 wt %. Optionally, the aerosol-forming substrate comprises between 1 and 20, or 3 and 15 wt % water. The moisture or water content of the substrate may be measured using a titration method. The moisture or water content of the substrate may be measured using the Karl Fisher method.

The aerosol-generating article may have a length (for example, an x dimension) of between 10 millimetres and 100 millimetres, or between 10 millimetres and 50 millimetres, for example between 12 millimetres and 30 millimetres, for example between 14 millimetres and 26 millimetres, for example between 16 millimetres and 24 millimetres, for example between 18 millimetres and 22 millimetres, for example about 18 millimetres, or about 19 millimetres, or about 20 millimetres, or about 21 millimetres, or about 22 millimetres.

The aerosol-generating article may have a width (for example, a y dimension) of between 5 millimetres and 20 millimetres, for example between 8 millimetres and 18 millimetres, for example between 10 millimetres and 16 millimetres, for example between 11 millimetres and 15 millimetres, for example between 12 millimetres and 14 millimetres, for example about 13 millimetres.

The aerosol-generating article may have a height (for example, a z dimension) of between 1 millimetres and 10 millimetres, for example between 1.2 millimetres and 8 millimetres, for example between 1.4 millimetres and 7 millimetres, for example between 1.6 millimetres and 6 millimetres, for example between 1.7 millimetres and 5 millimetres, for example about 1.7 millimetres, or about 4.5 millimetres, or about 2 millimetres, or about 3 millimetres, or about 4 millimetres.

The aerosol-generating article when viewed in plan may have a shape defining a polygon, a quadrilateral (for example, a rectangle or a square), oval, or circle, or a combination thereof. Where the aerosol-generating article comprises substantially planar upper and lower surfaces, one or both of the upper and lower surfaces when viewed in plan may have a shape defining a polygon, a quadrilateral (for example, a rectangle or a square), an oval, a circle, or a combination thereof. A perimeter of the aerosol-generating article when viewed in plan may be formed of a plurality of straight sides, a plurality of curved sides, or a combination of straight and curved sides. Where the aerosol-generating article comprises substantially planar upper and lower surfaces, a perimeter of one or both of the upper and lower surfaces when viewed in plan may have a shape defining a polygon, a quadrilateral (for example, a rectangle or a square), an oval, a circle, or a combination thereof.

The aerosol-forming substrate may be one of a plurality of component parts of the aerosol-generating article.

The aerosol-forming substrate may comprise nicotine. Nicotine may be present in the form of a tobacco material or may be in the form of a nicotine extract.

Preferably, the aerosol-forming substrate comprises, or consists of, homogenised tobacco material, for example a reconstituted tobacco material or a cast leaf tobacco material.

The aerosol-forming substrate may comprise, or consist of, a solid aerosol-forming material. The aerosol-forming substrate may comprise a liquid aerosol-forming material, for example a liquid aerosol-forming material retained within a porous matrix. The aerosol-forming substrate may comprise a gel aerosol-forming material.

The aerosol-forming substrate may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol-former to be or comprise glycerine.

The aerosol-forming substrate may comprise at least 1, 2, 5, 10, or 15 weight percent aerosol-former. The aerosol-forming substrate may comprise greater than 15 weight percent aerosol-former, for example greater than 20 weight percent, or greater than 25 weight percent, or greater than 30 weight percent, or greater than 40 weight percent, or greater than 50 weight percent aerosol-former.

The aerosol-forming substrate may comprise less than or equal to 30 percent by weight of aerosol former, less than or equal to 25 percent by weight of aerosol former, or less than or equal to 20 percent by weight of aerosol former. That is, the aerosol-forming substrate may have an aerosol former content of less than or equal to 30 percent by weight, less than or equal to 25 percent by weight, or less than or equal to 20 percent by weight.

The aerosol-forming substrate may comprise between 1 percent and 30 percent by weight of aerosol former, between 1 percent and 25 percent by weight of aerosol former, or between 1 percent and 20 percent by weight of aerosol former.

The aerosol-forming substrate may comprise between 5 percent and 30 percent by weight of aerosol former, between 5 percent and 25 percent by weight of aerosol former, or between 5 percent and 20 percent by weight of aerosol former.

The aerosol-forming substrate may comprise between 10 percent and 30 percent by weight of aerosol former, between 10 percent and 25 percent by weight of aerosol former, or between 10 percent and 20 percent by weight of aerosol former.

The aerosol-forming substrate may comprise between 15 percent and 30 percent by weight of aerosol former, between 15 percent and 25 percent by weight of aerosol former, or between 15 percent and 20 percent by weight of aerosol former.

The aerosol-forming substrate may comprise at least 50 percent by weight of aerosol former, at least 60 percent by weight of aerosol former, or at least 70 percent by weight of aerosol former.

The aerosol-forming substrate may comprise less than or equal to 85 percent by weight of aerosol former, less than or equal to 80 percent by weight of aerosol former, or less than or equal to 75 percent by weight of aerosol former.

The aerosol-forming substrate may comprise between 50 percent and 85 percent by weight of aerosol former, between 50 percent and 80 percent by weight of aerosol former, or between 50 percent and 75 percent by weight of aerosol former.

The aerosol-forming substrate may comprise between 60 percent and 85 percent by weight of aerosol former, between 60 percent and 80 percent by weight of aerosol former, or between 60 percent and 75 percent by weight of aerosol former.

The aerosol-forming substrate may comprise between 70 percent and 85 percent by weight of aerosol former, between 70 percent and 80 percent by weight of aerosol former, or between 70 percent and 75 percent by weight of aerosol former.

The aerosol-forming substrate may comprise nicotine. The aerosol-forming material may comprise natural nicotine, or synthetic nicotine, or a combination of natural nicotine and synthetic nicotine.

The aerosol-forming substrate may comprise at least 0.5 percent by weight of nicotine, at least 1 percent by weight of nicotine, at least 1.5 percent by weight of nicotine, or at least 2 percent by weight of nicotine. That is, the aerosol-forming substrate may have a nicotine content of at least 0.5 percent by weight, at least 1 percent by weight, at least 1.5 percent by weight, or at least 2 percent by weight.

The aerosol-forming substrate may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The aerosol-forming substrate may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material.

The aerosol-forming substrate may have a moisture content of about 5 to 25%, preferably of about 7 to 15%, at final product state. For example, the aerosol-forming substrate may be a homogenised tobacco material with a moisture of about 5 to 25%, preferably of about 7 to 15%, at final product state.

The aerosol-forming substrate may comprise tobacco leaf; for example about 15 to 45%, preferably of about 20 to 35% of a blend of tobacco leaf, incorporating at least one of the following tobacco types: bright tobacco; dark tobacco; aromatic tobacco. Tobacco material such as tobacco leaf is preferably ground and graded to a particle size of about 100 to 380 mesh, preferably of about 170 to 320 mesh. “Tobacco type” means one of the different varieties of tobacco, for example based on the distinct curing process that the tobacco undergoes before it is further processed in a tobacco product.

Examples of bright tobaccos are Flue-Cured Brazil, Indian Flue-Cured, Chinese Flue-Cured, US Flue-Cured such as Virginia tobacco, and Flue-Cured from Tanzania.

Examples of aromatic tobaccos are Oriental Turkey, Greek Oriental, semi-oriental tobacco but also Fire Cured, US Burley, such as Perique, and Rustica.

Examples of dark tobacco are Dark Cured Brazil Galpao, Burley Malawi or other African Burley, Sun Cured or Air Cured Indonesian Kasturi.

The aerosol-forming substrate may comprise Cellulose fibres. For example, the aerosol-forming substrate may comprise about 1 to 15% of cellulose fibres, preferably of about 3 to 7% of cellulose fibres. Preferably, cellulose fibres may have a length of about 10 to 250 μm, preferably of about 10 to 120 μm.

The aerosol-forming substrate may comprise organic fibres such as non-tobacco fibres, or tobacco fibres. For example, the aerosol-forming substrate may comprise about 5 to 20%, preferably about 7 to 15% of tobacco fibres. Tobacco fibres are preferably derived from stems and/or or stalks, graded to fibres of a length of about 10 to 350 μm, preferably of about 10 to 180 μm. The aerosol-forming substrate may comprise about 10 to 30%, preferably of about 15 to 25%, of a non-tobacco organic fibre. For example, organic fibres may derive from cellulose, cotton, wood, tea botanical varieties as sub-products, and sub-processed waste, the tea industry. Organic fibres are preferably of a length of about 10 to 400 μm, preferably of about 10 to 200 μm.

The aerosol-forming substrate may comprise a binder. For example, the aerosol-forming substrate may comprise about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. A preferable binder is guar.

The aerosol-forming substrate may comprise an organic botanical glycerite. For example, the aerosol-forming substrate may comprise about 15 to 55%, preferably of about 20 to 35%, of botanicals such as Clove, Echinacea sp., Fennel, Ginger, Hawthorn berry, Elderberry, Monarda, Mullein leaves, Nettle, Plantain, Turmeric, Yarrow, and compounds of those.

The aerosol-forming substrate may comprise organic botanical extracts. For example, the aerosol-forming substrate may comprise about 1 to 15%, preferably of about 2 to 7%, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

The aerosol-forming substrate may comprise botanical essential oils, for example about 0.5 to 5%, preferably of about 1 to 3%, of a botanical essential oil, for example a botanical essential oil such as of palm, coconut, and wooden-based essential oils.

The aerosol-forming substrate preferably comprises an aerosol-former, for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

According to a fifth aspect of the present disclosure, there is provided an aerosol-generating system comprising an aerosol-generating article and an aerosol-generating device. The aerosol-generating article may be an article as described herein, for example an article according to any of the first, second, third, or fourth aspects.

The aerosol-generating device may be a device for use with the aerosol-generating article to enable the generation, or release, of an aerosol.

The device may comprise a power source. The device may comprise a cavity for receiving at least a portion of the article. The device may comprise a heater. The device may comprise an inductive heater. Alternatively, or in addition, the device may comprise a resistive heater.

The device may be configured to heat the article, for example the substrate of the article, in use. The device may be configured to inductively heat the article, for example the substrate of the article, for example the thermally conductive particles where those particles comprise one or more susceptor materials, in use. Alternatively, or in addition, the device may be configured to resistively heat the article, for example the substrate of the article, in use.

As used herein, the term “aerosol-generating article” may refer to an article able to generate, or release, an aerosol.

As used herein, the term “aerosol-forming substrate” may refer to a substrate capable of releasing an aerosol or volatile compounds that can form an aerosol. Such volatile compounds may be released by heating the aerosol-forming substrate. An aerosol-forming substrate may comprise an aerosol-forming material. An aerosol-forming substrate may be adsorbed, coated, impregnated, or otherwise loaded onto a carrier or support. An aerosol-forming substrate may conveniently be part of an aerosol-generating article or smoking article.

As used herein, the term “aerosol-generating device” may refer to a device for use with an aerosol-generating article to enable the generation, or release, of an aerosol.

As used herein, the term “aerosol generating system” may refer to a combination of an aerosol-generating device and one or more aerosol-forming articles for use with the device. An aerosol-generating system may include additional components, such as a charging unit for recharging an on-board electric power supply in an electrically operated or electric aerosol-generating device.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-forming substrate or aerosol-generating article.

As used herein, the term “nicotine”, may be used to describe nicotine, nicotine base or a nicotine salt.

As used herein, the terms “proximal”, “distal”, “upstream” and “downstream” may be used to describe the relative positions of components, or portions of components, of the aerosol-generating article.

As used herein, the term “longitudinal” may refer to the direction corresponding to the main longitudinal axis of the aerosol-generating article, which extends between the upstream and downstream ends of the aerosol-generating article. During use, air may be drawn through the aerosol-generating article in the longitudinal direction.

As used herein, the term “sheet” may refer to a laminar element having a width and length substantially greater than the thickness thereof. The width of a sheet may be greater than 10 mm, preferably greater than 20 mm or 30 mm. In certain embodiments, sheets of material for use in forming aerosol-forming substrates as described herein may have a thickness of between 10 μm and about 1000 μm, for example between 10 μm and about 300 μm.

As used herein, the term “homogenised tobacco material” may encompass any tobacco material formed by the agglomeration of particles of tobacco material. Sheets or webs of homogenised tobacco material are formed by agglomerating particulate tobacco obtained by grinding or otherwise powdering of one or both of tobacco leaf lamina and tobacco leaf stems. In addition, homogenised tobacco material may comprise a minor quantity of one or more of tobacco dust, tobacco fines, and other particulate tobacco by-products formed during the treating, handling and shipping of tobacco. The sheets of homogenised tobacco material may be produced by casting, extrusion, paper making processes or other any other suitable processes known in the art.

The term “cast leaf” herein may refer to refer to a product made by a casting process that is based on casting a slurry comprising plant particles (for example, clove particles or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. 5,724,998 for making cast leaf tobacco. In a cast leaf process, particulate plant materials are produced by pulverizing, grinding, or comminuting parts of the plant. The particles produced from one or more plants are mixed with a liquid component, typically water, to form a slurry. Other components in the slurry may include fibres, a binder and an aerosol former. The particulate plant materials may be agglomerated in the presence of the binder. The slurry is cast onto a supportive surface and dried into a sheet of homogenized plant material. Preferably, homogenized plant material used in articles according to the present invention may be produced by casting. Such homogenized plant material may comprise agglomerated particulate plant material.

As used herein, resistance to draw is expressed with the units of pressure “mm H2O” or “mm WG” or “mm of water gauge” and may be measured in accordance with ISO 6565:2002.

As used herein, the term “thermally conductive particles” may refer to particles having a thermal conductivity greater than 1 W/(MK) in at least one direction at 25 degrees Celsius, for example in all directions at 25 degrees Celsius. The particles may exhibit anisotropic or isotropic thermal conductivity.

As used herein, the term “expanded graphite” may refer to a graphite-based material, or a material having a graphite-like structure. Expanded graphite may have carbon layers (similar to graphite, for example) with spacing between the carbon layers greater than the spacing found between carbon layers in regular graphite. Expanded graphite may have carbon layers with elements or compounds intercalated into spaces between the carbon layers.

As used herein, the term “particle size” may refer to a single dimension and may be used to characterise the size of a given particle. The dimension may be the diameter of a spherical particle occupying the same volume as the given particle. All particle sizes and particle size distributions herein can be obtained using a standard laser diffraction technique. Particle sizes and particle size distributions as stated herein may be obtained using a commercially available sensor, for example a Sympatec HELOS laser diffraction sensor.

As used herein, where not otherwise specified, the term “density” may be used to refer to true density. Thus, where not otherwise specified, the density of a powder or plurality of particles may refer to the true density of the powder or plurality of particles (rather than the bulk density of the powder or plurality of particles, which can vary greatly depending on how the powder or plurality of particles are handled). The measurement of true density can be done using a number of standard methods, these methods often being based on Archimedes'principle. The most widely used method, when used to measure the true density of a powder, includes the powder being placed inside a container (a pycnometer) of known volume, and weighed. The pycnometer is then filled with a fluid of known density, in which the powder is not soluble. The volume of the powder is determined by the difference between the volume as shown by the pycnometer, and the volume of liquid added (i.e. the volume of air displaced).

The invention is defined in the claims. However, below there is provided a non-exhaustive list of non-limiting examples. Any one or more of the features of these examples may be combined with any one or more features of another example, embodiment, or aspect described herein.

Ex1. An aerosol-generating article for use with an aerosol-generating device to generate an aerosol, the aerosol-generating article comprising:
an aerosol-forming substrate comprising thermally conductive particles, each of the thermally conductive particles having a thermal conductivity of at least 1 W/mK in at least one direction at 25 degrees Celsius,
wherein the aerosol-generating article is a planar aerosol-generating article having an article length, an article width, and an article thickness, the article thickness being no more than 0.5 times the article length and no more than 0.5 times the article width.

Ex2. An aerosol-generating article according to any preceding example, wherein the article thickness is no more than 0.2 times the article length and no more than 0.2 times the article width.

Ex3. An aerosol-generating article according to any preceding example, wherein the aerosol-forming substrate is a planar aerosol-forming substrate having a substrate length, a substrate width, and a substrate thickness, the substrate thickness being no more than 0.5 times the substrate length and no more than 0.5 times the substrate width.

Ex4. An aerosol-generating article according to example Ex3, wherein the substrate thickness is no more than 0.2 times the substrate length and no more than 0.2 times the substrate width.

Ex5. An aerosol-generating article according to any preceding example, wherein the aerosol-generating article comprises a corrugated element.

Ex6. An aerosol-generating article according to example Ex5, wherein the aerosol-forming substrate comprises the corrugated element.

Ex7. An aerosol-generating article according to example Ex5 or Ex6, wherein the corrugated element is or comprises a corrugated sheet of material bent or folded to form corrugations.

Ex8. An aerosol-generating article according to any of examples Ex5 to Ex7, wherein the corrugated element comprises at least some of the thermally conductive particles.

Ex9. An aerosol-generating article according to example Ex8, wherein at least some the thermally conductive particles of the corrugated element comprise or consist of one or more susceptor materials.

Ex10. An aerosol-generating article according to any of examples Ex5 to Ex9, wherein the corrugated element comprises an aerosol-forming material.

Ex11. An aerosol-generating article according to any of examples Ex5 to Ex10, wherein the aerosol-forming substrate comprises a first planar layer adjacent to, optionally in contact with, the corrugated element.

Ex12. An aerosol-generating article according to example Ex11, wherein the first planar layer comprises an aerosol-forming material.

Ex13. An aerosol-generating article according to any of examples Ex5 to Ex12, wherein the aerosol-forming substrate comprises a second planar layer adjacent to, optionally in contact with, the corrugated element.

Ex14. An aerosol-generating article according to example Ex13, wherein the second planar layer comprises an aerosol-forming material.

Ex15. An aerosol-generating article according to any of examples Ex5 to Ex10, wherein the aerosol-forming substrate comprises a first planar layer, a second planar layer, and an intermediate layer disposed between the first planar layer and the second planar layer, optionally wherein the intermediate layer comprises the corrugated element.

Ex16. An aerosol-generating article according to example Ex15, wherein the intermediate layer comprises the corrugated element.

Ex17. An aerosol-generating article according to example Ex15 or Ex16, wherein the intermediate layer comprises an aerosol-forming material.

Ex18. An aerosol-generating article according to example Ex15 or Ex16 or Ex17, wherein the first planar layer comprises at least some of the thermally conductive particles.

Ex19. An aerosol-generating article according to any of examples Ex15 to Ex18, wherein the second planar layer comprises at least some of the thermally conductive particles.

Ex20. An aerosol-generating article according to any of examples Ex15 to Ex19, wherein the intermediate layer comprises at least some of the thermally conductive particles, for example where the article is an article according to any of examples Ex16 to Ex19 and the corrugated element of the intermediate layer comprises at least some of the thermally conductive particles.

Ex21. An aerosol-generating article according to any of examples Ex11 to Ex12, or Ex13 to Ex14 when dependent on one of Ex11 or Ex12, or Ex15 to Ex20, wherein the first planar layer has a first region and a second region.

Ex22. An aerosol-generating article according to example Ex21, wherein the first region is closer to the corrugated element than the second region.

Ex23. An aerosol-generating article according to example Ex21 or Ex22, wherein a shortest distance between the first region and the corrugated element is less than a shortest distance between the second region and the corrugated element.

Ex24. An aerosol-generating article according to example Ex21, Ex22 or Ex23, wherein the first region is in contact with the corrugated element, for example in contact with a peak or a trough of the corrugated element.

Ex25. An aerosol-generating article according to any of examples Ex21 to Ex24, wherein the second region is not in contact with the corrugated element.

Ex26. An aerosol-generating article according to any of examples Ex11 to Ex12, or Ex13 to Ex14 when dependent on one of Ex11 or Ex12, or Ex15 to Ex20, or Ex21 to Ex25, wherein the first planar layer has one or more first portions and one or more second portions.

Ex27. An aerosol-generating article according to example Ex26, wherein the or each first portion is closer to the corrugated element than the or each second portion.

Ex28. An aerosol-generating article according to example Ex26 or Ex27, wherein a shortest distance between the or each first portion and the corrugated element is less than a shortest distance between the or each second portion and the corrugated element.

Ex29. An aerosol-generating article according to any of examples Ex26 to Ex28, wherein the or each first portion is in contact with the corrugated element, for example in contact with a peak or a trough of the corrugated element.

Ex30. An aerosol-generating article according to any of examples Ex26 to Ex29, wherein there are multiple first portions and each first portion is adjacent to, for example in contact with, a peak or a trough of the corrugated element which no other first portion is adjacent to or in contact with.

Ex31. An aerosol-generating article according to any of examples Ex26 to Ex30, wherein the or each second portion is not in contact with the corrugated element.

Ex32. An aerosol-generating article according to any of examples Ex26 to Ex31, wherein at least one first portion is located between two second portions.

Ex33. An aerosol-generating article according to any of examples Ex26 to Ex32, wherein at least one second portion is located between two first portions.

Ex34. An aerosol-generating article according to any of examples Ex21 to Ex25, or any of Ex26 to Ex33 when dependent on any of Ex21 to Ex25, wherein the first region has a different material composition to the second region.

Ex35. An aerosol-generating article according to any of examples Ex21 to Ex25, or any of Ex26 to Ex34 when dependent on any of Ex21 to Ex25, wherein:
the first region has a coating and the second region does not; or
the second region has a coating and the first region does not; or
the first region and the second region have different coatings.

Ex36. An aerosol-generating article according to Ex34 or Ex35, wherein the second region comprises a greater proportion, on a dry weight basis, of at least one component, such as a flavouring or botanical, having a vaporisation temperature of less than 250 or 200 degrees Celsius at atmospheric pressure, than the first region.

Ex37. An aerosol-generating article according to any of Examples Ex26 to Ex33, or any of Ex34 to Ex36 when dependent on any of Ex26 to Ex33, wherein the or each first portion has a different material composition to the or each second portion.

Ex38. An aerosol-generating article according to example Ex37, wherein:
the or each first portion has a coating and the or each second portion does not; or
the or each second portion has a coating and the or each first portion does not; or
the or each first portion and the or each second portion have different coatings.

Ex39. An aerosol-generating article according to example Ex37 or Ex38, wherein the or each second portion comprises a greater proportion, on a dry weight basis, of at least one component, such as a flavouring or botanical, having a vaporisation temperature of less than 250 or 200 degrees Celsius at atmospheric pressure, than the or each first portion.

Ex40. An aerosol-generating article according to any of examples Ex15 to Ex20, or any of Examples Ex21 to Ex39 when dependent on any of Ex15 to Ex20, wherein the first planar layer is substantially parallel to the second planar layer.

Ex41. An aerosol-generating article according to example Ex40, wherein the first planar layer comprises a substantially planar upper surface defined by a length extending in an x direction and a width extending in a y direction, and the second planar layer comprises a substantially planar lower surface defined by a length extending in an x direction and a width extending in a y direction.

Ex42. An aerosol-generating article according to any of examples Ex15 to Ex20, or any of Examples Ex21 to Ex41 when dependent on any of Ex15 to Ex20, wherein the substantially planar upper surface and the substantially planar lower surface are vertically spaced from each other by a height, for example a height equal to the substrate thickness, defined in a z direction.

Ex43. An aerosol-generating article according to any of examples Ex15 to Ex20, or any of Examples Ex21 to Ex42 when dependent on any of Ex15 to Ex20, wherein the corrugated element is attached to, and optionally in contact with, one or both of the first planar layer and the second planar layer.

Ex44. An aerosol-generating article according to any of examples Ex15 to Ex20, or any of Examples Ex21 to Ex43 when dependent on any of Ex15 to Ex20, wherein a first plurality of channels are defined between the upper layer and the corrugated element, and a second plurality of channels are defined between the corrugated element and the lower layer.

Ex45. An aerosol-generating article according to any preceding example, wherein the article comprises:
a first planar external surface;
a second planar external surface;
a cavity;
a frame positioned between the first planar external surface and the second planar external surface, the frame at least partially defining the cavity;
an air inlet;
an air outlet; and
an airflow passage extending between the air inlet and the air outlet through the cavity, wherein the aerosol-forming substrate is positioned between the first planar external surface and the second planar external surface.

Ex46. An aerosol-generating article according to example Ex45 when dependent on any of examples Ex15 to Ex20, wherein: the first planar layer comprises the first planar external surface; and the second planar layer comprises the second planar external surface.

Ex47. An aerosol-generating article according to example Ex45 or Ex46, wherein the frame comprises a peripheral wall at least partially circumscribing or encircling the cavity

Ex48. An aerosol-generating article according to example Ex45 or Ex46 or Ex47, wherein the article comprises a first planar external layer and a second planar external layer, in which the first planar external layer forms the first planar external surface and the second planar external layer forms the second planar external surface.

Ex49. An aerosol-generating article according to example Ex48 when dependent on any of examples Ex15 to Ex20, wherein the first planar layer is or comprises the first planar external layer; and the second planar layer is or comprises the second planar external layer.

Ex50. An aerosol-generating article according to any of examples Ex48 to Ex49, wherein at least one of the first planar external layer, the second planar external layer, and the frame may comprise or consist of aerosol-forming substrate.

Ex51. An aerosol-generating article according to any of examples Ex45 to Ex50, wherein the cavity is substantially empty.

Ex52. An aerosol-generating article according to any of examples Ex45 to Ex50, wherein aerosol-forming material is positioned within the cavity, for example wherein part or all of the aerosol-forming substrate is positioned within the cavity.

Ex53. An aerosol-generating article according to any of examples Ex45 to Ex50 or Ex52, wherein a corrugated element or corrugated layer is positioned within the cavity.

Ex54. An aerosol-generating article according to any of examples Ex45 to Ex50 or Ex52, when dependent on example Ex5, wherein the corrugated element is positioned within the cavity

Ex55. An aerosol-generating article according to any preceding example, wherein each of the thermally conductive particles have a thermal conductivity of at least 2, 5, 10, 20, 50, 100, 200 or 500 W/mK in at least one direction at 25 degrees Celsius.

Ex56. An aerosol-generating article according to any preceding example, wherein each of the thermally conductive particles comprises or consists of one or more susceptor materials.

Ex57. An aerosol-generating article according to any preceding example, wherein each of the thermally conductive particles comprises or consists of one or more susceptor materials and is inductively heatable during use of the aerosol-generating article with the aerosol-generating device to a temperature of at least 100, 200 or 300 degrees Celsius.

Ex58. An aerosol-generating article according to any preceding example, wherein some or all of the thermally conductive particles are non-metallic particles.

Ex59. An aerosol-generating article according to any preceding example, wherein some or all of the thermally conductive particles comprise carbon, for example at least 10, 30, 50, 70, 90, 95, 98, or 99 wt % carbon.

Ex60. An aerosol-forming substrate according to any preceding example, wherein some or all of the thermally conductive particles are graphite particles.

Ex61. An aerosol-forming substrate according to any preceding example, wherein some or all of the thermally conductive particles are expanded graphite particles.

Ex62. An aerosol-forming substrate according to any preceding example, wherein the thermally conductive particles comprise one or more of: graphite particles, expanded graphite particles, diamond particles such as artificial diamond particles, graphene particles, carbon nanotubes, ferrite particles, and charcoal particles.

Ex63. An aerosol-generating article according to any preceding example, wherein some or all of the thermally conductive particles comprise one or more of: one or more metals, one or more metallic materials, one or more alloys, and one or more intermetallics.

Ex64. An aerosol-generating article according to any preceding example, wherein some or all of the thermally conductive particles comprise one or more of: copper, aluminium, and nickel.

Ex65. An aerosol-generating article according to any preceding example, wherein the thermally conductive particles have a particle size distribution having a number D10 particle size, wherein the number D10 particle size is at least 0.1, 0.2, 0.5, 1, 2, 5, 10, 20, 50, 100, 200, or 500 microns.

Ex66. An aerosol-generating article according to any preceding example, wherein the thermally conductive particles have a particle size distribution having a number D10 particle size, wherein the number D10 particle size is no more than 1,000, 500, 200, 100, 50, 20, 10, 5, 2, 1, 0.5, or 0.2 microns.

Ex67. An aerosol-generating article according to any preceding example, wherein the thermally conductive particles have a particle size distribution having a number D50 particle size, wherein the number D50 particle size is at least 0.1, 0.2, 0.5, 1, 2, 5, 10, 20, 50, 100, 200, or 500 microns.

Ex68. An aerosol-generating article according to any preceding example, wherein the thermally conductive particles have a particle size distribution having a number D50 particle size, wherein the number D50 particle size is no more than 1,000, 500, 200, 100, 50, 20, 10, 5, 2, 1, 0.5, or 0.2 microns.

Ex69. An aerosol-generating article according to any preceding example, wherein the thermally conductive particles have a particle size distribution having a number D90 particle size, wherein the number D90 particle size is at least 0.1, 0.2, 0.5, 1, 2, 5, 10, 20, 50, 100, 200, or 500 microns.

Ex70. An aerosol-generating article according to any preceding example, wherein the thermally conductive particles have a particle size distribution having a number D90 particle size, wherein the number D90 particle size is no more than 1,000, 500, 200, 100, 50, 20, 10, 5, 2, 1, 0.5, or 0.2 microns.

Ex71. An aerosol-generating article according to any preceding example, wherein the thermally conductive particles have a particle size distribution having a volume D10 particle size, wherein the volume D10 particle size is at least 0.1, 0.2, 0.5, 1, 2, 5, 10, 20, 50, 100, 200, or 500 microns.

Ex72. An aerosol-generating article according to any preceding example, wherein the thermally conductive particles have a particle size distribution having a volume D10 particle size, wherein the volume D10 particle size is no more than 1,000, 500, 200, 100, 50, 20, 10, 5, 2, 1, 0.5, or 0.2 microns

Ex73. An aerosol-generating article according to any preceding example, wherein the thermally conductive particles have a particle size distribution having a volume D50 particle size, wherein the volume D50 particle size is at least 0.1, 0.2, 0.5, 1, 2, 5, 10, 20, 50, 100, 200, or 500 microns.

Ex74. An aerosol-generating article according to any preceding example, wherein the thermally conductive particles have a particle size distribution having a volume D50 particle size, wherein the volume D50 particle size is no more than 1,000, 500, 200, 100, 50, 20, 10, 5, 2, 1, 0.5, or 0.2 microns.

Ex75. An aerosol-generating article according to any preceding example, wherein the thermally conductive particles have a particle size distribution having a volume D90 particle size, wherein the volume D90 particle size is at least 0.1, 0.2, 0.5, 1, 2, 5, 10, 20, 50, 100, 200, or 500 microns.

Ex76. An aerosol-generating article according to any preceding example, wherein the thermally conductive particles have a particle size distribution having a volume D90 particle size, wherein the volume D90 particle size is no more than 1,000, 500, 200, 100, 50, 20, 10, 5, 2, 1, 0.5, or 0.2 microns.

Ex77. An aerosol-generating article according to any preceding example, wherein the thermally conductive particles have a particle size distribution having a number D10 particle size, a number D90 particle size, a volume D10 particle size, and a volume D90 particle size, wherein:
the number D90 particle size is no more than 50, 40, 30, 20, 10, or 5 times the number D10 particle size; or
the volume D10 particle size is no more than 50, 40, 30, 20, 10, or 5 times the volume D10 particle size; or
both the number D90 particle size is no more than 50, 40, 30, 20, 10, or 5 times the number D10 particle size and the volume D10 particle size is no more than 50, 40, 30, 20, 10, or 5 times the volume D10 particle size.

Ex78. An aerosol-generating article according to any preceding example, wherein the thermally conductive particles have a particle size distribution and one or both of a number D10 particle size and a volume D10 particle size is between 1 and 20 microns.

Ex79. An aerosol-generating article according to any preceding example, wherein the thermally conductive particles have a particle size distribution, wherein one or both of a number D90 particle size and a volume D90 particle size is between 50 and 300 microns or between 50 and 200 microns.

Ex80. An aerosol-generating article according to any preceding example, wherein each of the thermally conductive particles has a particle size of at least 0.1, 0.2, 0.5, 1, 2, 5, 10, 20, 50, 100, 200, or 500 microns.

Ex81. An aerosol-generating article according to any preceding example, wherein each of the thermally conductive particles has a particle size of no more than 1,000, 500, 200, 100, 50, 20, 10, 5, 2, 1, 0.5, or 0.2 microns.

Ex82. An aerosol-generating article according to any preceding example, wherein each of the thermally conductive particles has three mutually perpendicular dimensions, a largest dimension of the three dimensions being no more than 10, 8, 5, 3, or 2 times larger than one or both of a smallest dimension of the three dimensions and a second largest dimension of the three dimensions.

Ex83. An aerosol-generating article according to any preceding example, wherein each of the thermally conductive particles is substantially spherical.

Ex84. An aerosol-generating article according to any preceding example, wherein the thermally conductive particles comprise at least 10, 20, 50, 100, 200, 500, or 1000 particles.

Ex85. An aerosol-generating article according to any preceding example, wherein the substrate comprises, on a dry weight basis, at least 10, 15, 20, 25, 30, 35, 40, 45, 50, 55, 60, 65, 70, 75, 80 or 85 wt % of the thermally conductive particles.

Ex86. An aerosol-generating article according to any preceding example, wherein the substrate comprises, on a dry weight basis, no more than 85, 80, 75, 70, 65, 60, 55, 50, 45, 40, 35, 30, 25, 20, or 15 wt % of the thermally conductive particles.

Ex87. An aerosol-generating article according to any preceding example, wherein the substrate comprises, on a dry weight basis, between 10 and 90, 20 and 90, 30 and 90, 40 and 90, 50 and 90, 60 and 90, 70 and 90, 80 and 90, 10 and 80, 20 and 80, 30 and 80, 40 and 80, 50 and 80, 60 and 80, 70 and 80, 10 and 70, 20 and 70, 30 and 70, 40 and 70, 50 and 70, 60 and 70, 10 and 60, 20 and 60, 30 and 60, 40 and 60, 50 and 60, 10 and 50, 20 and 50, 30 and 50, 40 and 50, 10 and 40, 20 and 40, 30 and 40, 10 and 30, 20 and 30, or 10 and 20 wt % of the thermally conductive particles.

Ex88. An aerosol-generating article according to any preceding example, wherein the aerosol-forming substrate has a thermal conductivity of greater than 0.05, 0.1, 0.15, 0.2, 0.3, 0.4, 0.5, 0.75, 1, 1.25, or 1.5 W/(mK) at 25 degrees Celsius.

Ex89. An aerosol-generating article according to any preceding example, wherein the aerosol-forming substrate has a density of less than 1500, 1050, 1000, 950, 900, 850, 800, 850, 800, 750, 700, or 650kg/m³.

Ex90. An aerosol-generating article according to any preceding example, wherein the aerosol-forming substrate has a density of between 500 and 900 or 600 and 800kg/m³.

Ex91. An aerosol-generating article according to any preceding example, wherein the aerosol-forming substrate has a moisture content of between 1 and 20, or 3 and 15 wt %.

Ex92. An aerosol-generating article according to any preceding example, wherein the aerosol-forming substrate comprises between 1 and 20, or 3 and 15 wt % water.

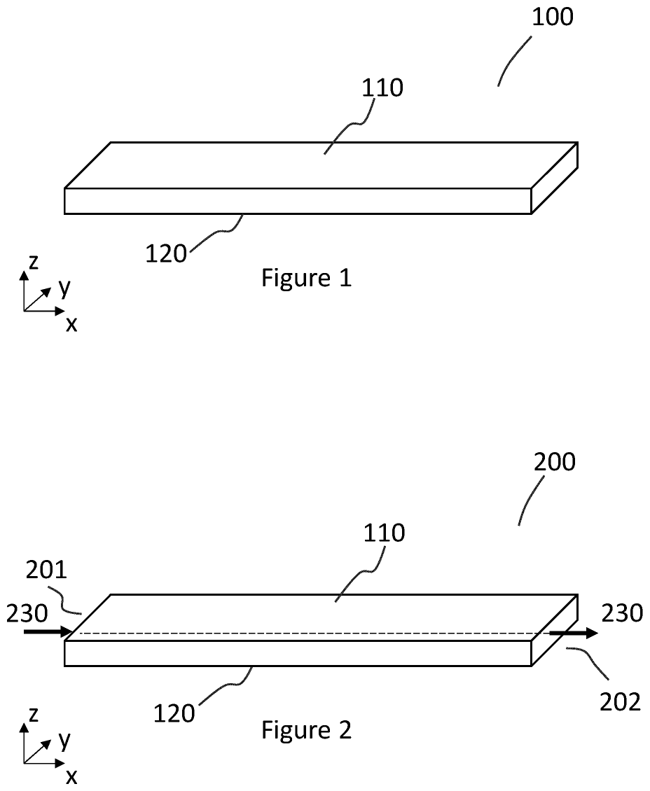

Examples will now be further described with reference to the figures in which:
FIG. 1 is a perspective side view of an aerosol-generating article according to a first embodiment of the present disclosure;

FIG. 2 is a perspective side view of an aerosol-generating article according to a second embodiment of the present disclosure;

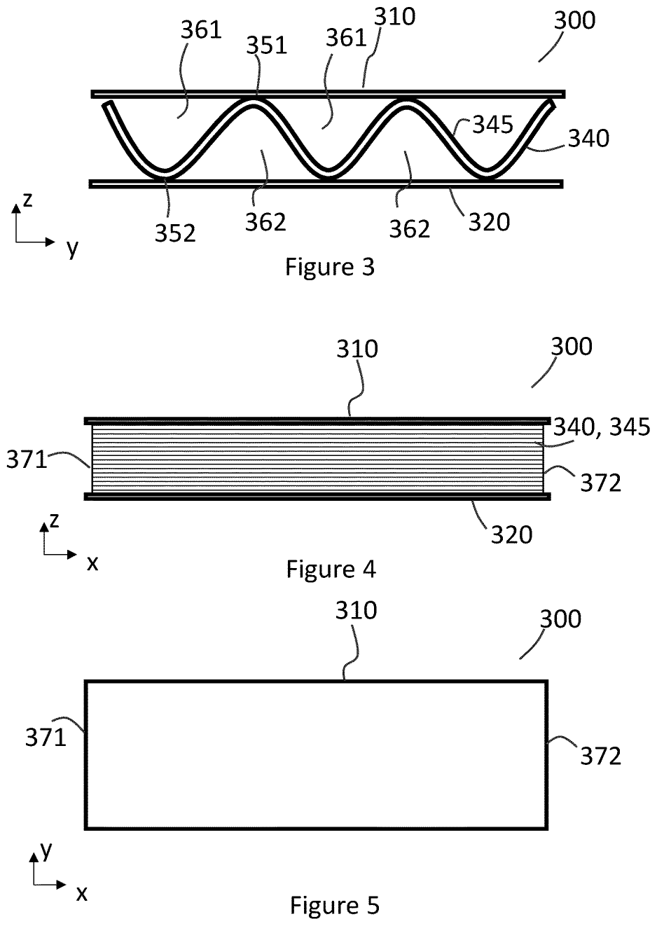

FIG. 3 is a schematic end view of an aerosol-generating article according to a third embodiment of the present disclosure;

FIG. 4 is a schematic side view of the aerosol-generating article of FIG. 3;

FIG. 5 is a schematic plan view of the aerosol-generating article of FIG. 3;

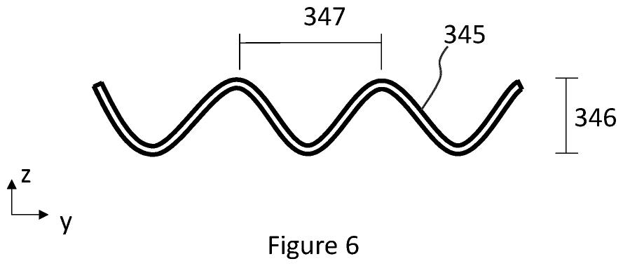

FIG. 6 shows a schematic illustration of a corrugated element as used in the aerosol-generating article of FIG. 3;

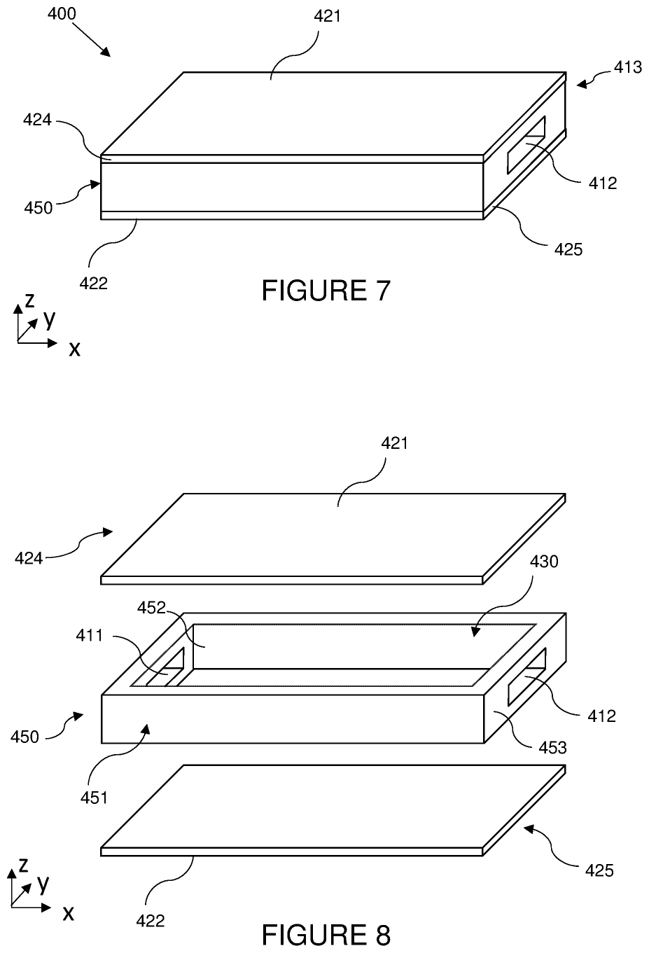

FIG. 7 shows a perspective view of an aerosol-generating article according to a fourth embodiment of the present disclosure;

FIG. 8 shows an exploded perspective view of the aerosol-generating article of FIG. 7;

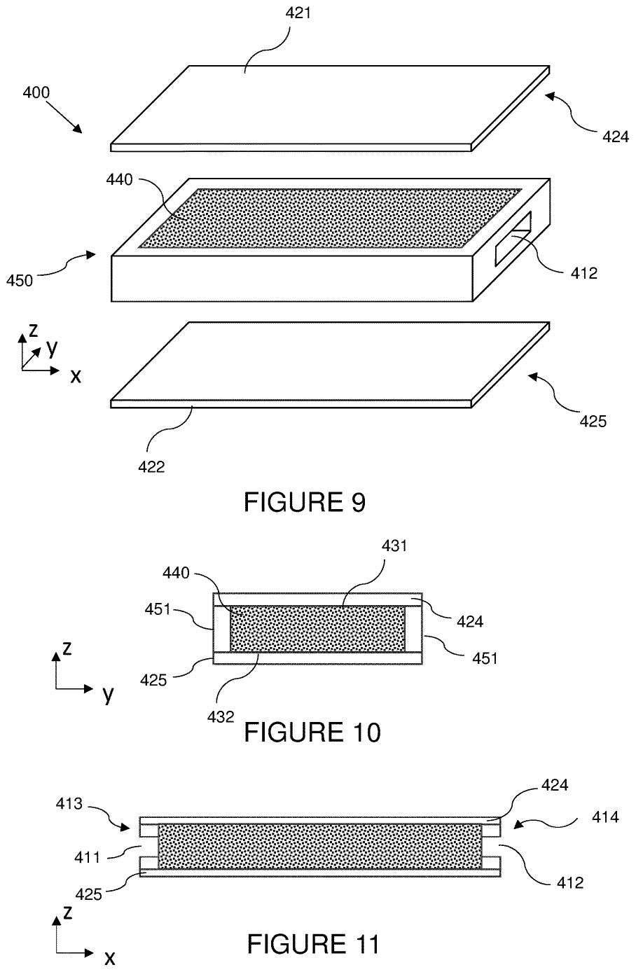

FIG. 9 shows a further exploded perspective view of the aerosol-generating article of FIG. 7;

FIG. 10 shows a schematic transverse cross-sectional view of the aerosol-generating article of FIG. 7;

FIG. 11 shows a schematic longitudinal cross-sectional view of the aerosol-generating article of FIG. 7;

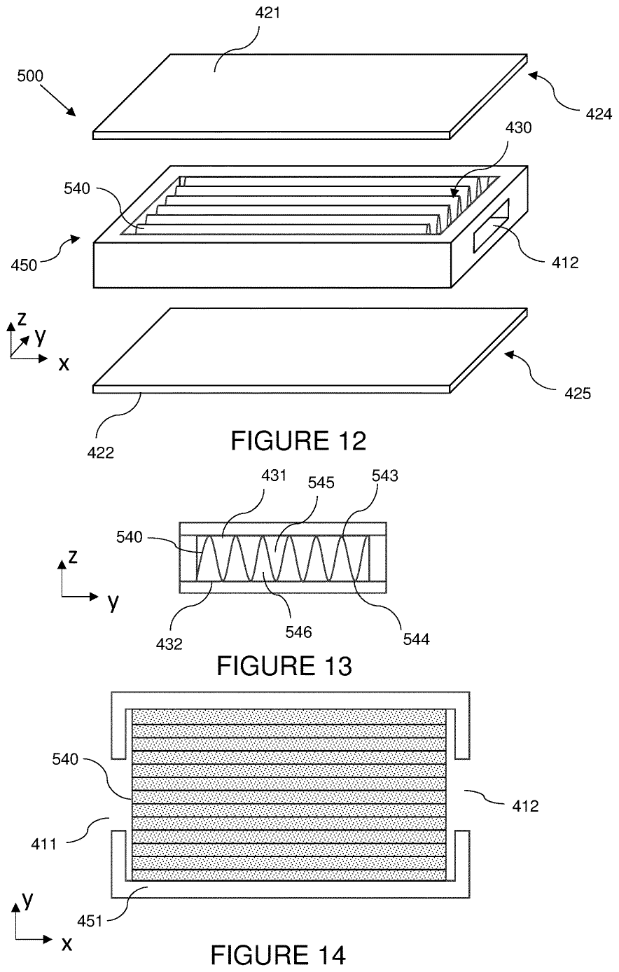

FIG. 12 shows an exploded perspective view of an aerosol-generating article according to a fifth embodiment of the present disclosure;

FIG. 13 shows a schematic transverse cross-sectional view of the aerosol-generating article of FIG. 12;

FIG. 14 shows a schematic lateral cross-sectional view of the aerosol-generating article of FIG. 12.

FIG. 1 illustrates a perspective side view of an aerosol-generating article 100 according to a first embodiment of the present disclosure. The aerosol-generating article 100 has upper and lower surfaces 110, 120 which are flat or planar.

The aerosol-generating article 100 comprises an aerosol-forming substrate (not shown). In one embodiment, the aerosol-generating article 100 may consist substantially of aerosol-forming substrate. In another embodiment, the aerosol-forming substrate may be one of a plurality of component parts of the aerosol-generating article 100. The aerosol-forming substrate may be encircled or enclosed within an interior of the aerosol-generating article 100. The aerosol-forming substrate may at least partially define an exterior of the aerosol-generating article 100; for example, one or both of the upper and lower surfaces 110, 120 may comprise or consist of aerosol-forming substrate.

In this embodiment, the aerosol-forming substrate comprises aerosol-forming material and a plurality of thermally conductive particles (not shown) dispersed substantially uniformly therein.

In this embodiment, the thermally conductive particles are graphite particles, specifically commercially available FP 99.5 (>99.5% purity) graphite particles from Graphit Kropfmül GmbH, AMG Graphite GK, though other particles or mixtures of particles could be used.

Each of the thermally conductive particles is substantially spherical in shape and has a thermal conductivity far greater than 1 W/(mK) in all directions at 25 degrees Celsius. The particle size distribution of the thermally conductive particles has a volume D10 particle size of around 6 microns, a volume D50 particle size of around 21 microns, and a volume D90 particle size of around 55 microns. The thermally conductive particles make up around 10 wt % of the aerosol-forming substrate, on a dry weight basis.

The aerosol-generating article 100 has a length, extending in an x dimension, of 80 millimetres, a width, extending in a y dimension, of 15 millimetres, and a height (which may also be referred to as a thickness), extending in a z dimension, of 3.6 millimetres.

FIG. 2 illustrates a perspective side view of an aerosol-generating article 200 according to a second embodiment of the present disclosure, being a variant of aerosol-generating article 100. Features in common with aerosol-generating article 100 are referred to with like reference signs. Features identical to the aerosol-generating article 100 are not repeated below.

An air flow path 230 is defined through the aerosol-generating article 200 between the upper and lower surfaces 110, 120. The air flow path 230 extends between opposed first and second ends 201, 202 of the aerosol-generating article 200. The first end 201 may define a distal end of the aerosol-generating article 200, and the second end 202 may define a proximal end of the aerosol-generating article. The air flow path 230 may be directed towards a mouth of a user to allow a user to inhale aerosol generated in consequence of heating of aerosol-forming substrate of the aerosol-generating article 200.

FIGS. 3, 4, and 5 illustrate respectively an end view, a side view, and a plan view of an aerosol-generating article 300 according to a third embodiment of the present disclosure.

The aerosol-generating article 300 comprises an aerosol-forming substrate comprising a planar upper layer 310, a planar lower layer 320, and an intermediate or separation layer 330 arranged between the upper layer 310 and lower layer 320.

The planar upper layer 310 is formed from a sheet of aerosol-forming material having a thickness of 300 microns. In this embodiment, the planar upper layer 310 does not comprise thermally conductive particles, though in other embodiments, it could. The planar lower layer 320 is formed from a sheet of aerosol-forming material having a thickness of 300 microns. In this embodiment, the planar upper layer 310 does not comprise thermally conductive particles, though in other embodiments, it could. The intermediate layer 340 is a corrugated element formed from a corrugated sheet of aerosol-forming material 345 with a plurality of thermally conductive particles (not shown) substantially uniformly dispersed therein. The combination of the planar lower layer 320, the planar upper layer 310, and the corrugated sheet of aerosol-forming material 345 with the thermally conductive particles dispersed therein, may together be considered the aerosol-forming substrate of the aerosol-generating article 300.

In this embodiment, the thermally conductive particles are graphite particles, specifically commercially available FP 99.5 (>99.5% purity) graphite particles from Graphit Kropfmül GmbH, AMG Graphite GK, though other particles or mixtures of particles could be used.

Each of the thermally conductive particles is substantially spherical in shape and has a thermal conductivity far greater than 1 W/(mK) in all directions at 25 degrees Celsius. The particle size distribution of the thermally conductive particles has a volume D10 particle size of around 6 microns, a volume D50 particle size of around 21 microns, and a volume D90 particle size of around 55 microns. The thermally conductive particles make up around 10 wt % of the aerosol-forming substrate, on a dry weight basis.

FIG. 6 illustrates the corrugated sheet of aerosol-forming material 345. The corrugations have an amplitude 346 of 3 millimetres and a wavelength 347 of 3 millimetres. The sheet of aerosol-forming substrate 345 forming the intermediate layer 340 has a thickness of 150 microns.

Points of intersection 351, 352 between the upper layer 310 and the intermediate layer 340 and between the lower layer 320 and the intermediate layer 340 comprise an adhesive that joins the respective layers.

The aerosol-generating article 300 has a length, extending in an x dimension, of 80 millimetres, a width, extending in a y dimension, of 15 millimetres, and a height (or thickness), extending in a z dimension, of 3.6 millimetres.

Corrugations of the intermediate layer 340 form a first set of longitudinally extending channels 361 that are bounded by the upper layer 310 and the intermediate layer 340, and a second set of longitudinally extending channels 362 bounded by the lower layer 320 and the intermediate layer 340. The first and second sets of longitudinally extending channels 361, 362 extend through the length of the aerosol-forming substrate between a proximal end 371 of the substrate 345 and a distal end 372 of the substrate 345. The longitudinally extending channels 361, 362 define an airflow path through the substrate 345. The airflow path, therefore, passes over both sides of the sheet of aerosol-forming substrate 345. The porosity of the aerosol-generating article along the airflow path is in the region of 90%. This provides a very low resistance to draw (RTD) of less than 5 mm H2O. In fact, the RTD is close to zero.

The planar upper layer 310 comprises a plurality of first portions and a plurality of second portions. The first portions of the planar upper layer 310 are those within around 0.5 mm of the point or line of intersection 351 between the upper layer 310 and the intermediate layer 340, which extends along the entire length of the intermediate layer 340 in this embodiment. The second portions of the planar upper layer 310 are the remaining portions of the planar upper layer 310. The first portions have a different material composition to the second portions. Specifically, the first portions do not comprise a botanical or flavourant. But the second portions comprise 5 wt % of a botanical, specifically clove, on a dry weight basis.

The planar upper layer 310 may be formed in a number of ways, for example by first forming a substantially homogenous sheet of aerosol-forming material, and then impregnating or otherwise adding the clove into the second portions.

The planar lower layer 320 is formed from a substantially homogeneous sheet of aerosol-forming material. Similarly to the planar upper layer 310, the planar lower layer 320 comprises a plurality of first portions and a plurality of second portions. The first portions of the planar lower layer 320 are those within around 0.5 mm of the point or line of intersection 352 between the planar lower layer 320 and the intermediate layer 340, which extends along the entire length of the intermediate layer 340 in this embodiment. The second portions of the planar lower layer 320 are the remaining portions of the planar lower layer 320. The upper surfaces of the second portions of the planar lower layer 320 are coated with a botanical, specifically clove in this embodiment. The upper surfaces of the first portions of the planar lower layer 320 do not have a coating.

During use of the aerosol-generating article 300, the aerosol-forming substrate is inserted into a cavity of an aerosol-generating device and inductively heated. Specifically, an alternating current is passed through an inductor coil of the device, the inductor coil surrounding the cavity in which the article 300 is received, thereby generating a fluctuating magnetic field in the cavity. This fluctuating magnetic field induces eddy currents and hysteresis losses in the graphite particles, which are susceptor particles, causing them to heat up. The device could also resistively heat the substrate, for example using heating surfaces which at least partially define the cavity, the heating surfaces being placed in contact with one or both of the upper surface of the planar upper layer 310 and the lower surface of the planar lower layer 320 when the article is received in the cavity.

The heating of the substrate causes the release of volatile compounds from aerosol-forming material in the substrate, which are then entrained in air drawn into the channels 361, 362 via the distal end 372 of the article 300 in response to a user sucking on the proximal end 372 of the article 300 or a mouthpiece (not shown) attached to the proximal end 372 of the article 300. The volatile compounds then cool and condense to form an aerosol which may be drawn out of the channels 361, 362 of the aerosol-generating article 300 via the proximal end 371 and inhaled by a user.

In the embodiment shown in FIGS. 3-5, where inductive heating is used, for example as described above, the corrugated element is heated to a higher temperature than the upper and lower planar layers 310, 320 because of the presence of the graphite particles in the corrugated element being inductively heated. Thus, since the first portions of the upper and lower planar layers 310, 320 are closer to the corrugated element than the second portions of the upper and lower planar layers 310, 320, the first portions of the upper and lower planar layers 310, 320 are heated to a higher temperature than the second portions of the upper and lower planar layers 310, 320. In view of this, advantageously, the ingredients of the aerosol-forming substrate which do not need to be heated to a particularly high temperature to be vaporised, specifically the botanical clove, are part of, or coated onto, the second portions of the upper and lower planar layers 310, 320. A greater proportion of the heat transferred from the corrugated element to the upper and lower planar layers 310, 320 is therefore directed to ingredients which need to be heater to higher temperatures compared to, for example, completely homogeneous upper and lower planar layers 310, 320 without coatings.

FIG. 7 shows an aerosol-generating article 400 according to a fourth embodiment of the present disclosure. The aerosol-generating article 400 comprises a first planar external layer 424 forming a first planar external surface 421, a second planar external layer 425 forming a second planar external surface 422, and a frame 450 positioned between the first planar external layer 424 and the second planar external layer 425. The second planar external surface 422 is positioned parallel to the first planar external surface 421.

FIGS. 8 and 9 show exploded views of the aerosol-generating article 400 of FIG. 7. The frame 450 circumscribes and at least partially defines a cavity 430. FIG. 8 shows the cavity 430 in an empty state. FIG. 9 shows the cavity 430 filled with aerosol-forming substrate 440. FIGS. 10 and 11 show respective transverse and longitudinal cross-sectional views of the aerosol-generating article 400 when the cavity 430 is filled with aerosol-forming substrate 440.

The first planar external layer 424 and the second planar external layer 425 are made from cigarette paper having a thickness of 35 micrometres and are in physical contact, with and bonded to, the frame 450. The first planar external layer 424 overlies a first end of the cavity 430 and forms a first cavity end wall 431. The second planar external layer 425 overlies a second end of the cavity 430 and forms a second cavity end wall 432, the second cavity end wall 432 being opposite to the first cavity end wall 431. That is, the frame 450, the first planar external layer 424 and the second planar external layer 425 collectively define the cavity 430.

The frame 450 has a hollow cuboid shape and is made from cardboard. The frame 450 defines an aperture extending through the height (also referred to as the thickness) of the frame 450 and the aperture at least partially forms the cavity 430 of the aerosol-generating article 400. The frame 450 comprises a peripheral wall 451 that circumscribes the cavity 430. The peripheral wall 451 includes a front wall 413 and a back wall 414. In more detail, the peripheral wall 451 is defined by an inner transverse surface 452 of the frame 450 and an outer transverse surface 453 of the frame 450. The inner transverse surface 452 of the peripheral wall 451 at least partially defines a perimeter of the cavity 430. The outer transverse surface 453 of the peripheral wall 451 at least partially defines a perimeter of the aerosol-generating article 400. The peripheral wall 451 has a radial thickness measured between the inner transverse surface 452 of the frame 450 and the outer transverse surface 453 of the frame 450 of about 5 millimetres.

An air inlet 411 and an air outlet 412 are defined by, and extend through, the peripheral wall 451 of the frame 450. More specifically, the air inlet 411 extends through the front wall 413 and the air outlet 412 extends through the back wall 414. The air inlet 411 and the air outlet 412 have an equivalent diameter of 5 millimetres. An airflow passage extends between the air inlet 411 and the air outlet 412 through the cavity 430.

As shown in FIGS. 9 to 11, an aerosol-forming substrate 440 is positioned within the cavity 430. The aerosol-forming substrate 440 is in the form of cut filler. The cut filler is formed from shreds of an aerosol-forming material comprising homogenised tobacco, and an aerosol-former content of 5 percent by weight on a dry weight basis. In addition, a plurality of thermally conductive particles are substantially uniformly dispersed throughout the aerosol-forming material prior to the material being shredded to form the cut filler. Thus, thermally conductive particles are dispersed through the aerosol-forming substrate of this embodiment.

In this embodiment, the thermally conductive particles are graphite particles, specifically commercially available FP 99.5 (>99.5% purity) graphite particles from Graphit Kropfmül GmbH, AMG Graphite GK, though other particles or mixtures of particles could be used.

Each of the thermally conductive particles is substantially spherical in shape and has a thermal conductivity far greater than 1 W/(mK) in all directions at 25 degrees Celsius. The particle size distribution of the thermally conductive particles has a volume D10 particle size of around 6 microns, a volume D50 particle size of around 21 microns, and a volume D90 particle size of around 55 microns. The thermally conductive particles make up around 10 wt % of the aerosol-forming substrate.

As shown, the aerosol-forming substrate 440 fills the entire volume of the cavity 430.

The aerosol-generating article 400 has a cuboid shape and has a height (or thickness) extending in a z dimension, as measured between the first planar external surface 421 and the second planar external surface 422, of 8 millimetres, a width extending in a y dimension of 40 millimetres and a length extending in an x dimension of 60 millimetres. The frame 450 has a height (or thickness) extending in a z dimension of 7.93 millimetres, a width extending in a y dimension of 40 millimetres and a length extending in an x dimension of 60 millimetres. The cavity 430 has a height (or thickness) extending in a z dimension of 7.93 millimetres, a width extending in a y dimension of 39.93 millimetres and a length extending in an x dimension of 52 millimetres.

FIG. 12 shows an aerosol-generating article 500 according to a fifth embodiment of the present disclosure. Features in common with aerosol-generating article 400 are referred to with like reference signs. Features identical to the aerosol-generating article 400 are not repeated.

Aerosol-generating article 500 differs from aerosol-generating article 400 in that the aerosol-forming substrate is in the form of a sheet of aerosol-forming material 540, in particular a corrugated sheet of homogenised tobacco material with the thermally conductive particles substantially uniformly dispersed therein. FIGS. 13 and 14 show respective transverse and lateral cross-section views of the aerosol-generating article 500 of FIG. 12.

The corrugated sheet of homogenised tobacco material 540 comprises a plurality of parallel corrugations having a plurality of substantially parallel peaks 543 and troughs 544. The plurality of parallel corrugations are defined by a corrugation profile which, as seen in FIG. 13, is sinusoidal. The plurality of parallel corrugations have a corrugation wavelength of about 4.6 millimetres. The corrugation amplitude is approximately the same as the height (or thickness) of the cavity 430, as shown by the peaks 543 and troughs 544 coinciding with the first cavity end wall 431 and the second cavity end wall 432, respectively.

The plurality of parallel corrugations form a plurality of channels 545 between the sheet of aerosol-forming material 540 and the first cavity end wall 431, and a plurality of channels 546 between the sheet of aerosol-forming material 540 and the second cavity end wall 432. The plurality of channels 545, 546 extend in a longitudinal direction of the aerosol-generating article 500 and form at least a portion of the airflow passage extending between the air inlet 411 and the air outlet 412.

During use of each of the aerosol-generating articles 400, 500, the aerosol-forming substrate 440, 540 is heated up to cause the aerosol-forming substrate 440, 540 to release volatile compounds, which are then entrained in air drawn through the air inlet 411 into the cavity 430. The volatile compounds then cool and condense to form an aerosol which may be drawn out of the aerosol-generating article 400, 500 through the air outlet 412.

For exemplary purposes applicable to embodiments described above, a composition of a suitable aerosol-forming material may be as follows. Percentages are given in weight percent with respect to the product in its final state. The aerosol-forming substrate may have a moisture of about 5 to 25%, preferably of about 7 to 15%, at final product state. The aerosol-forming substrate may further comprise the following:
1. Tobacco leaf; for example about 15 to 45%, preferably of about 20 to 35% of a blend of tobacco leaf, incorporating at least one of the following tobacco types: bright tobacco; dark tobacco; aromatic tobacco. Tobacco material is ground and graded to a particle size of about 100 to 380 mesh, preferably of about 170 to 320 mesh.
2. Cellulose fibres; for example about 1 to 15%, preferably of about 3 to 7%, of cellulose fibres, of a length of about 10 to 250 μm, preferably of about 10 to 120 μm.
3. Tobacco fibres; for example about 5 to 20%, preferably of about 7 to 15% of tobacco fibres, as filler, of any tobacco type or a blend of tobacco types. Tobacco fibres are preferably derived from stems and/or or stalks, graded to fibres of a length of about 10 to 350 μm, preferably of about 10 to 180 μm.
4. Binder; for example about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. The preferable binder is guar.
5. Aerosol-former; for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

“Tobacco type” means one of the different varieties of tobacco, for example based on the distinct curing process that the tobacco undergoes before it is further processed in a tobacco product.

For exemplary purposes, a composition of a further aerosol-forming substrate, which may also be suitable for use as the aerosol-forming material in embodiments described above is described below. Percentages are given in weight percent with respect to the product in its final state. The aerosol-forming substrate may comprise:
1. An aerosol-former such as Glycerin; for example about 10 to 40%, preferably of about 20 to 30%.
2. Organic fibres; for example about 10 to 30%, preferably of about 15 to 25%, of any botanical variety suitable and with purity to comply with applicable FDA F&B grade requirements, as commonly available in the market. For example, organic fibres may derive from cellulose, cotton, wood, tea botanical varieties as sub-products, and sub-processed waste, of F&B tea industry. Organic fibres are preferably of a length of about 10 to 400 μm, preferably of about 10 to 200 μm.
3. Organic botanical glycerite; for example about 15 to 55%, preferably of about 20 to 35%, of botanicals such as Clove, Echinacea sp., Fennel, Ginger, Hawthorn berry, Elderberry, Monarda, Mullein leaves, Nettle, Plantain, Turmeric, Yarrow, and compounds of those.
4. Organic botanical extracts; for example about 1 to 15%, preferably of about 2 to 7%, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

Alternatively, such aerosol-forming substrate may also contain botanical essential oils of about 0.5 to 5%, preferably of about 1 to 3%, such as of palm, coconut, and wooden-based essential oils.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A” ±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein. The terms “in which” and “wherein” are used synonymously through this specification.

1.-15. (canceled)

16. An aerosol-generating system comprising an aerosol-generating device and an aerosol-generating article for the aerosol-generating device to generate an aerosol,
the aerosol-generating device being configured to resistively heat the aerosol-generating article, and
the aerosol-generating article comprising an aerosol-forming substrate comprising thermally conductive particles, each of the thermally conductive particles having a thermal conductivity of at least 1 W/mK in at least one direction at 25 degrees Celsius,
wherein the aerosol-generating article is a planar aerosol-generating article having an article length, an article width, and an article thickness, the article thickness being no more than 0.5 times the article length and no more than 0.5 times the article width.

17. The aerosol-generating system according to claim 16, wherein the aerosol-forming substrate is a planar aerosol-forming substrate having a substrate length, a substrate width, and a substrate thickness, the substrate thickness being no more than 0.5 times the substrate length and no more than 0.5 times the substrate width.

18. The aerosol-generating system according to claim 16, wherein the aerosol-generating article further comprises a corrugated element.

19. The aerosol-generating system according to claim 18, wherein the aerosol-forming substrate further comprises the corrugated element.

20. The aerosol-generating system according to claim 18, wherein the corrugated element comprises at least some of the thermally conductive particles.

21. The aerosol-generating system according to claim 18, wherein the corrugated element comprises an aerosol-forming material.

22. The aerosol-generating system according to claim 18, wherein the aerosol-forming substrate further comprises a first planar layer adjacent to the corrugated element, the first planar layer comprising an aerosol-forming material.

23. The aerosol-generating system according to claim 18,
wherein the aerosol-forming substrate further comprises a first planar layer, a second planar layer, and an intermediate layer disposed between the first planar layer and the second planar layer, and
wherein the intermediate layer comprises the corrugated element.

24. The aerosol-generating system according to claim 22, wherein the first planar layer comprises at least some of the thermally conductive particles.

25. The aerosol-generating system according to claim 22,
wherein the first planar layer has a first region and a second region,
wherein a shortest distance between the first region and the corrugated element is less than a shortest distance between the second region and the corrugated element, and
wherein the first region has a different material composition from the second region.

26. The aerosol-generating system according to claim 22,
wherein the first planar layer has a first region and a second region,
wherein a shortest distance between the first region and the corrugated element is less than a shortest distance between the second region and the corrugated element, and
wherein the first region has a coating and the second region does not, or the second region has a coating and the first region does not, or the first region and the second region have different coatings.

27. The aerosol-generating system according to claim 16, wherein some or all of the thermally conductive particles comprise at least 10 weight percent carbon.

28. The aerosol-generating system according to claim 16, wherein the aerosol-forming substrate further comprises, on a dry weight basis, at least 60 percent by weight of aerosol former.

29. The aerosol-generating system according to claim 16, wherein the thermally conductive particles have a particle size distribution with a D10 volume particle size of between 1 micron and 20 microns.

30. The aerosol-generating system according to claim 16, wherein the thermally conductive particles have a particle size distribution with a D90 volume particle size of between 30 microns and 300 microns.
